(19) United States
(12) Patent Application Publication
(10) Pub. No.: US 2014/0149307 A1
(43) Pub. Date: May 29, 2014

(54) APPARATUS AND SERVER FOR ON-LINE ACCEPTING POSTAL MATTER AND METHODS FOR THE SAME

(71) Applicant: Electronics and Telecommunications Research Institute, Daejeon (KR)

(72) Inventors: Jin Hyoung PARK, Cheongju-si (KR); Heon Gyu LEE, Daejeon (KR)

(21) Appl. No.: 13/907,873

(22) Filed: Jun. 1, 2013

(30) Foreign Application Priority Data
Nov. 26, 2012 (KR) 10-2012-0134646

(51) Int. Cl. G06Q 10/08

(52) U.S. Cl. CPC G06Q 10/083
USPC 705/330

(57) ABSTRACT

Provided is an apparatus for on-line accepting a postal matter. The apparatus for on-line accepting a postal matter according to the present invention includes a user terminal configured to transmit acceptation information for accepting a postal matter through a communication session for on-line accepting a user's postal matter or receive a control command for accepting the postal matter; and a postal matter processing unit configured to extract the acceptation information from the postal matter or perform an operation for accepting the postal matter according to the acceptation control command.

### CROSS-REFERENCE TO RELATED APPLICATIONS

This application claims priority to and the benefit of Korean Patent Application No. 10-2012-0134646 filed in the Korean Intellectual Property Office on Nov. 26, 2012, the entire contents of which are incorporated herein by reference.

### TECHNICAL FIELD

The present invention relates to a system for on-line accepting a postal matter and a method for the same.

### BACKGROUND ART

In order to distribute postal matter accepting work concentrated at a predetermined time at an acceptation desk of a main post office, an unmanned apparatus for accepting a postal matter in which a customer can directly accept a small or large amount of postal matters has been developed. In a related art, the unmanned apparatus for accepting a postal matter includes a user display unit, a postal address image acquiring unit, a postal weight measuring unit, an electronic postmarking unit, a settlement unit, a postal matter loading unit, and the like, and the customer can accept postal matters having a predetermined standard for him/herself by the following process.

1. Select an accepted postal matter (general post, registered post, parcels, international post, and the like)

2. Input postal matter information (the number of accepted postal matters, destination information, and the like)

3. Acquire a postal matter image (verifying a standard, reading a barcode, acquiring address information, and the like)

4. Measure a weight

5. Calculate postal charges

6. Electronic postmark (issue label)

7. Store a postal matter

The unmanned apparatus is installed at underground stations and public institutions to accept the postal matter outside the post office, and as a result, additional effects such as extension of a postal work time and improvement of customer's convenience have been obtained.

Meanwhile, as problems such as reduction of local postal matter amount with the development of digital media and increase in a post office operating cost burden according to labor cost rising are magnified, an unmanned post office configured by the unmanned apparatus for accepting the postal matter has been proposed as the next alternative. However, since repulsion about the unmanned apparatus or a user's load may occur in the case of an information minority group, there are many problems for introduction of the unmanned post office.

### SUMMARY OF THE INVENTION

The present invention has been made in an effort to provide an apparatus for automatically accepting a postal matter and a method for on-line accepting a postal matter which a customer more easily uses based on image communication between the customer and a desk staff in a remote post office and on-line control of the apparatus for accepting the postal matter by the desk staff targeted at information minority groups.

An exemplary embodiment of the present invention provides an apparatus for on-line accepting a postal matter, including: a user terminal configured to transmit acceptation information for accepting a postal matter through a communication session for on-line accepting a user's postal matter or receive a control command for accepting the postal matter; and a postal matter processing unit configured to extract the acceptation information from the postal matter or perform an operation for accepting the postal matter according to the acceptation control command.

Another exemplary embodiment of the present invention provides a server for on-line accepting a postal matter, including: a communication session generating unit configured to receive a request for generation of a communication session for on-line accepting a user's postal matter and generate the session; and an on-line postal matter accepting unit configured to receive the acceptation information through the communication session or transmit a control command for accepting the postal matter.

Yet another exemplary embodiment of the present invention provides a method for on-line accepting a postal matter, including: requesting generation of a communication session for on-line accepting a user's postal matter; transmitting acceptation information for accepting the postal matter through the generated communication session; receiving a control command for accepting the postal matter through the generated communication session; and performing an operation for accepting the postal matter according to the acceptation control command.

Still another exemplary embodiment of the present invention provides a processing method for on-line accepting a postal matter, including: receiving a request for generation of a communication session for on-line accepting a user's postal matter; generating the communication session; receiving the acceptation information through the generated communication session; and transmitting a control command for accepting the postal matter through the generated communication session.

According to the present invention, a customer accepts a postal matter by an apparatus for on-line accepting the postal matter through image communication with a desk staff in a remote post office and on-line control of the apparatus for accepting the postal matter by the desk staff, and as a result, since separate knowledge and method are not required at the time of accepting the postal matter, the postal matter can be more easily accepted, and particularly, user's convenience and familiarity for old people in agricultural and fishing areas, disabled people, and other information minority groups may be improved.

It is also possible to accept non-standard postal matters and express postal matters which can not be accepted by an existing unmanned postal matter accepting apparatus, and provide various optional services, and since manpower for accepting the postal matter is flexibly usable, it is most beneficial to reduce labor costs and construct unmanned post offices.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a system for on-line accepting a postal matter according to an exemplary embodiment of the present invention.

FIG. 2 is a diagram illustrating a process of the system for on-line accepting a postal matter according to the exemplary embodiment of the present invention.

FIG. 3 is a block diagram illustrating a user terminal of an apparatus for on-line accepting a postal matter according to an exemplary embodiment of the present invention.

FIG. 4 is a block diagram illustrating a postal matter processing unit of the apparatus for on-line accepting a postal matter according to the exemplary embodiment of the present invention.

FIG. 5 is an exemplified diagram illustrating a configuration of the user terminal of the apparatus for on-line accepting a postal matter according to the exemplary embodiment of the present invention.

FIG. 6 is an exemplified diagram illustrating a configuration of a postal matter box according to the exemplary embodiment of the present invention.

FIG. 7 is a flowchart illustrating a method for on-line accepting a postal matter according to an exemplary embodiment of the present invention.

FIGS. 8A to 8D are flowcharts illustrating a method for on-line accepting a postal matter for each postal matter type according to an exemplary embodiment of the present invention.

FIG. 9 is a flowchart illustrating a processing method for on-line accepting a postal matter according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will, be described in detail with reference to the accompanying drawings.

The following contents just exemplify a principle of the present invention. Therefore, although not clearly described or illustrated in this specification, those skilled in the art can implement the principle of the present invention and create various apparatuses included in the concept and the scope of the present invention. It needs to be understood that in principle, all conditional terms and exemplary embodiments listed in this specification are clearly intended to understand the concept of the present invention, and the present invention is not limited to the exemplary embodiments and states which are particularly listed as described above.

The objects, features, and advantages become clearer through the following detailed description relating to the accompanying drawings, and as a result, those skilled in the art can easily implement the technical spirit of the present invention, in describing the present invention, well-known related functions or configurations will not be described in detail since the detailed description for the related functions or configurations may unnecessarily obscure the understanding of the present invention. Hereinafter, exemplary embodiments of the present invention will be described in detail with reference to the accompanying drawings.

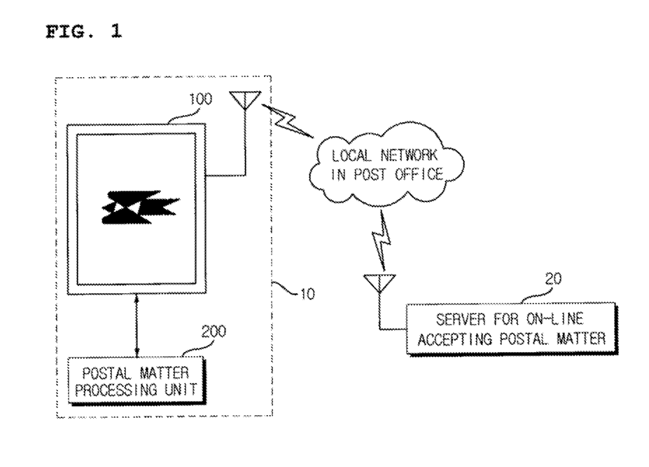

FIG. 1 is a configuration diagram illustrating a system for on-line accepting a postal matter according to an exemplary embodiment of the present invention.

In the system for on-line accepting a postal matter according to the exemplary embodiment, a postal matter is accepted through communication between a customer and a desk staff in a remote post office connected with the customer by a server 20 for on-line accepting a postal matter, and a physical acceptation process is taken by a postal acceptation apparatus.

A user 1 requests a service to an apparatus 10 for on-line accepting a postal matter in order to accept a postal matter, and the apparatus 10 for on-line accepting a postal matter requests communication session connection with a post office desk receptionist to the server 20 for on-line accepting a postal matter. The server 20 for on-line, accepting a postal matter finds a current responsive receptionist to connect the found responsive receptionist with the user, and as a result, communication between the user and the desk receptionist is possible.

The receptionist accepts the postal matter through image communication with the user and on-line control, transmits the corresponding acceptation information to an integrated postal information system which is a post office computing system for final acceptation, and finds and opens a usable post-office box (postal matter or parcel storage box). Thereafter, the user inputs his/her own postal matter into the opened post-office box and then the acceptation process ends.

Referring to FIG. 1, the system for on-line accepting a postal matter according to the exemplary embodiment includes the apparatus 10 for on-line accepting a postal matter and the server 20 for on-line accepting postal matter.

The apparatus 10 for on-line accepting a postal matter according to the exemplary embodiment transmits acceptation information for accepting the postal matter through the communication session for on-line acceptation of the user's postal matter, or receives a control command for accepting the postal matter to perform an operation for the acceptation of the postal matter.

The server 20 for on-line accepting a postal matter receives a request for generation of the communication session for the on-line acceptation of the user's postal matter and generates the session, and then receives the acceptation information through the communication session or transmits the control command for the acceptation of the postal matter.

That is the system for on-line accepting a postal matter according to the exemplary embodiment accepts the postal matter online with mutual communication between the user and the receptionist through the communication session generated by the apparatus 10 for on-line accepting a postal matter and the server 20 for on-line accepting a postal matter.

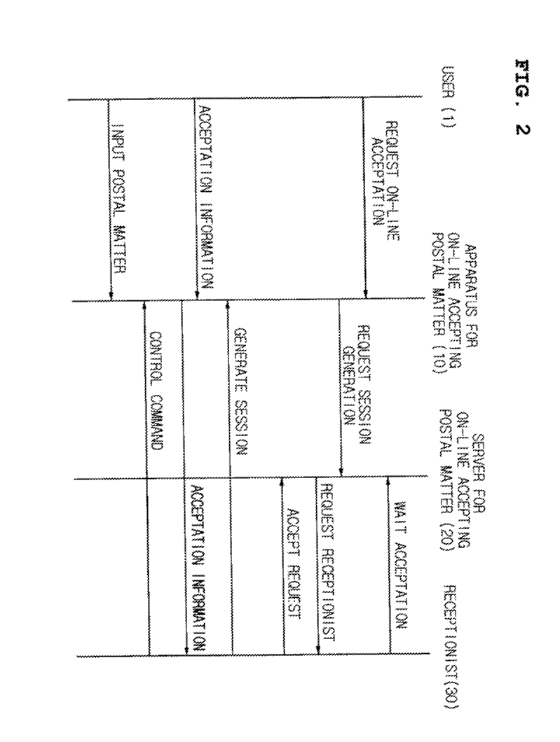

Referring to FIG. 2, when describing the process of the system for on-line accepting a postal matter according to the exemplary embodiment in detail, a first post-office desk receptionist is connected to the server 20 for on-line accepting a postal matter through an on-line acceptation terminal to be in an acceptation waiting state. Thereafter, the user requests a postal automation acceptation service through, for example, a smart kiosk of the apparatus 10 for on-line accepting a postal matter, and the request is transmitted to the server 20 for on-line accepting a postal matter.

The server 20 for on-line accepting a postal matter receiving the request retrieves a current responsive receptionist to transfer the user's request to the receptionist. Thereafter, on-line acceptation is performed through the communication session connection and the communication with the user by acceptance of the receptionist.

The desk receptionist may accept the postal matter in the integrated postal information system by using the acceptation information received from the user, and a physical on-line acceptation (standard calculation, weight measurement, certification stamp issue, and the like) may be performed through on-line control of the apparatus 10 for on-line accepting a postal matter.

After completing the acceptation, the receptionist induces the user to directly input the postal matter to the post-office box.

Hereinafter, each configuration of the apparatus 10 for on-line accepting a postal matter according to the exemplary embodiment will be described.

The apparatus 10 for on-line accepting a postal matter includes a user terminal 100 and a postal matter processing unit 200.

The user terminal 100 serves as a mediator for communication between the user and the receptionist, and transmits and receives information through a voice or image information which is supplied by a user interface environment in the exemplary embodiment.

The acceptation information for accepting the postal matter includes standard information, address information, and weight information of the postal matter, information on a transferring method of the postal matter, and the like, and may be directly input by the user or extracted through an operational result according to the control command in the postal matter processing unit 200.

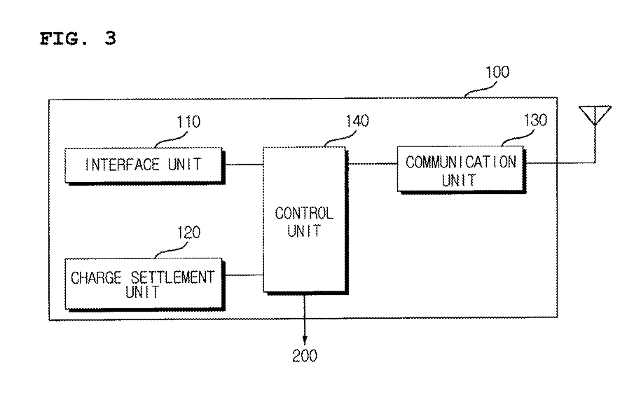

Referring to FIG. 3, in more detail, the user terminal 100 includes an interface unit 110, a charge settlement unit 120, a communication unit 130, and a control unit 140.

The interface unit 110 provides a user interface environment, so that the user can input the acceptation information for transmission through the communication session.

The system for on-line accepting a postal matter according to the exemplary embodiment is performed based on mutual information exchange through the communication session between the user and the receptionist of the post office and thus may provide an interface environment for exchanging the information to the user.

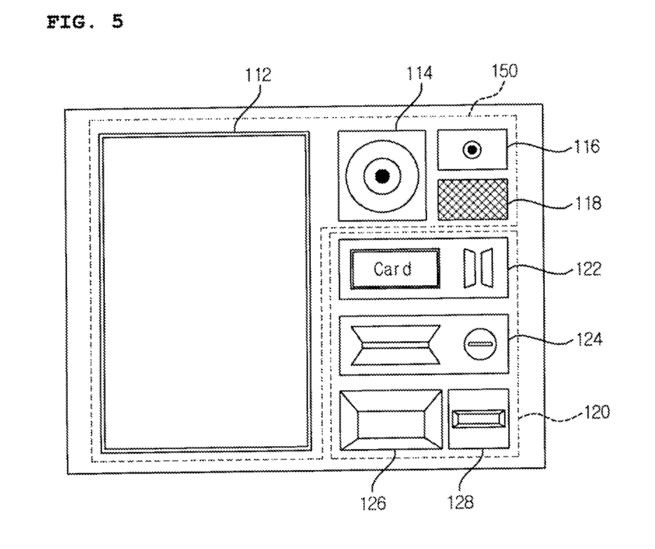

Accordingly, the user terminal 100 according to the exemplary embodiment may be configured by the kiosk having the structure illustrated in FIG. 5.

The interface unit 110 may include configurations such as a display unit 112 for a user's contact point, a camera 114 for image communication, a mike 116, and a speaker 118 in order to provide the user interface environment.

The display unit 112 may include a touch screen, and perform an on-line acceptation request function of the postal matter and an image communication function through a screen of the display unit. A first acceptation user attempts communication connection with the receptionist through a service request button displayed in the display unit 112 and can see a face of the desk receptionist through the display screen after connection.

The camera 114 transmits an image of the postal matter, and an appearance, behaviour, and the like of the user to the receptionist in real time, and enables the receptionist to estimate a size or a type of the accepted postal matter. A user's inappropriate behaviour such as an input error of the postal matter and damage to the apparatus may be handled.

The mike 116 and the speaker 118 serve to transmit and receive voice information between the user and the receptionist.

The charge settlement unit 120 enables the user to settle a postal charge. Settlement by non-cash media such as a credit card and a transport card may be performed by a card settlement unit 122, and settlement by general currency (cash) may be performed by a cash settlement unit 124. Finally, the charge settlement unit 120 includes a change returning unit 126 and a receipt issuing unit 128 for returning the change and issuing the receipt.

The communication unit 130 transmits the information for acceptation by using the communication session connected with the receptionist through the server 20 for on-line accepting a postal matter and receives the control command for acceptation from the receptionist.

The control unit 140 controls the operations of the interface unit 110, the charge settlement unit 120, and the communication unit 130 described above and transfers the control command received from the communication unit 130 to the postal matter processing unit 200, and thus allows the postal matter processing unit to perform the operation.

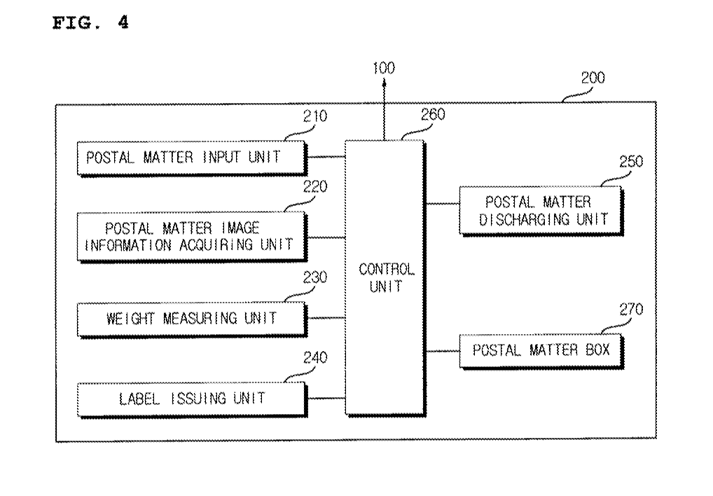

Hereinafter, the postal matter processing unit 200 according to the exemplary embodiment will be described with reference to FIG. 4. The postal matter processing unit 200 according to the exemplary embodiment may include a postal matter input unit 210, a postal matter image information acquiring unit 220, a weight measuring unit 230, a label issuing unit 240, a postal matter discharging unit 250, a postal matter box 270, and a control unit 260. The postal matter input unit 210 moves the user's postal matter to the inside of a postal matter auto-handler. The user places the postal matter to be accepted on the postal matter input unit 210 and moves the postal matter to the postal matter image information acquiring unit 220 which is the next step, by using a conveyer belt at the bottom.

An actual image of the postal matter is photographed by using a camera installed at the top of the postal matter image information acquiring unit 220. The acquired image information is transmitted to the user terminal 110 by the control unit, and in this case, the user terminal 100 performs an image reading function and an image transmitting function. A standard of the postal matter for calculating the postal charge is determined through the image reading function.

The user terminal 100 recognizes address characters for extracting addressee and addressor address information through the image reading function with respect to the image photographed by the image information acquiring unit 220. The user terminal 100 may analyze a registered barcode for accepting a provisional registered postal matter.

The weight measuring unit 230 measures an actual weight of the postal matter by using a balance and transmits a measured value to the user terminal 100. In this case, the user terminal 100 calculates a postal charge by using the determined standard information and the weight of the postal matter to inform the calculated postal charge to the user and the receptionist. The postal matter moves to the label issuing unit 240 by using a conveyer belt at the bottom after measuring the weight, and moves to the postal matter discharging unit 250 when the user requests acceptation cancel before the postal matter moves to the label issuing unit 240 and thus intermediate discharge is performed.

The label issuing unit 240 issues a label for accepting the postal matter by using a label printing and issuing apparatus, and the label issuing unit 240 is divided into a small label issuing unit 240 and a large label issuing unit 240 according to a size of the label. The small label issuing unit 240 issues a certificate stamp (postal stamp) for a letter (mail) and a barcode for a registered letter, and the large label issuing unit 240 issues a signified paper for national and international parcel postal matters. The signified paper for national parcel includes addressee and addresser address information and content information, and additionally includes barcode information at the time of requesting a registration service. The signified paper for international parcel is differently output according to small flight packaging and express mail. In the case of the small flight packaging, the signified paper is similar to that of the national parcel, and in the case of the express mail, a printed content is different according to content and a delivery service. Table 1 represents output contents according to detailed classification of the express mail.

TABLE 1

| | Document/non- | |
|---|---|---|
| Service | document | |
| classification | classification | Output label |
| EMS | Document | Attachment of goods, storage of |
| | Total of three | post office, and storage of |
| | sheets | sender |
| | Non-document | Attachment of goods, storage of |
| | (Total of five | post office, |
| | sheets) | storage of sender, customs |
| | | declaration of delivery nation, |
| | | and |
| | | customs declaration of sending |
| | | nation |
| EMS premium | Document | Attachment of goods, storage of |
| | (Total of four | post office, |
| | sheets) | storage of sender, and storage |
| | | of TNT |
| | Non-document | Attachment of goods, storage of |
| | (Total of four | post office, |
| | sheets) | storage of sender, and storage |
| | | of TNT |

The label is issued by the desk receptionist, and the receptionist controls the label issuing unit 240 online so as to print the label based or acceptation information received from the user and charge information according to weight measurement.

The postal matter discharging unit 250 may be used for collection by a postman of general and registered postal matters, but as described above, may additionally include an intermediate discharging unit 250 in which the postal matter moves to the postal matter discharging unit 250 when the user requests the cancellation of the acceptation to be discharged in the middle.

The postal matter box 270 for storing the accepted postal matter is configured by an individual parcel storage box 272, a user selection unit 274, a general postal matter input unit 276, and a registered postal matter input unit 278.

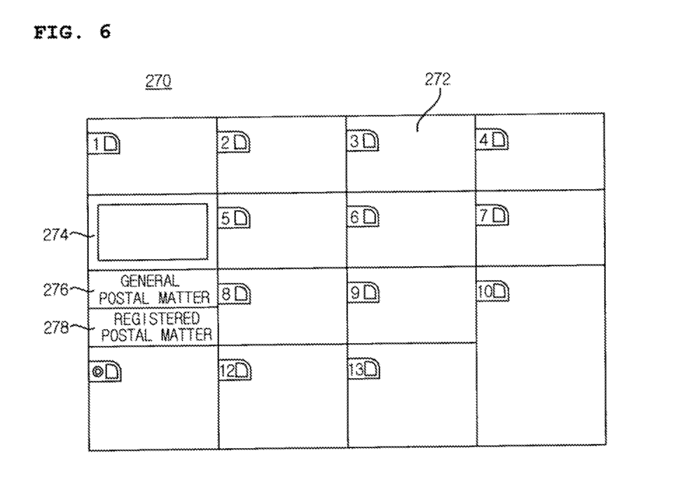

The postal matter box 270 according to the exemplary embodiment may be configured by the structure of the shape illustrated in FIG. 6.

The individual parcel storage box 272 is a space for storing the parcel, and the receptionist opens a storage box suitable for a size of the accepted postal matter of the user among empty storage boxes and induces the user to directly input the postal matter.

The user selection unit 274 receives user input to select the postal matter box at the time of being used for not acceptation but storage.

The general postal matter input unit 276 and the registered postal matter input unit 278 are used when the accepted postal matters of the user are a general postal matter and a registered postal matter, respectively, and the general postal matter input unit. 276 and the registered postal matter input unit 276 induce the user to input the postal matter by a voice without a separate apparatus control function by the receptionist.

Hereinafter, an on-line accepting method through the apparatus 10 for on-line accepting a postal matter and the server according to the exemplary embodiment described above will be described.

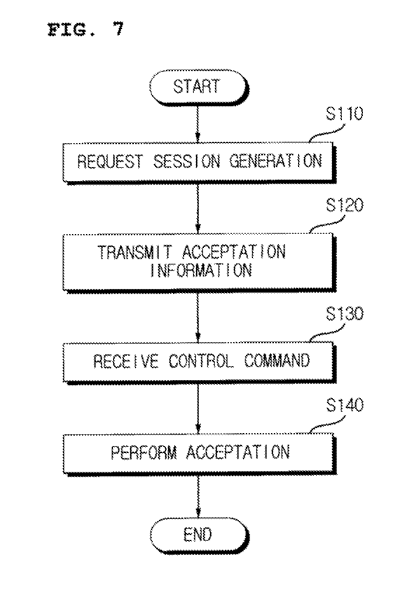

Referring to FIG. 7, the method for on-line accepting the postal matter according to the exemplary embodiment includes a session generation requesting step (S110), an acceptation information transmitting step (S120), a control command receiving step (S130), and an acceptation performing step (S140).

The session generation requesting step (S110) requests generation of a communication session for on-line accepting a user's postal matter.

The acceptation information transmitting step (S120) transmits acceptation information for accepting the postal matter through the generated communication session.

The control command receiving step (S130) receives a control command for accepting the postal matter through the generated communication session.

The acceptation performing step (S140) performs an operation for accepting the postal matter according to the acceptation control command.

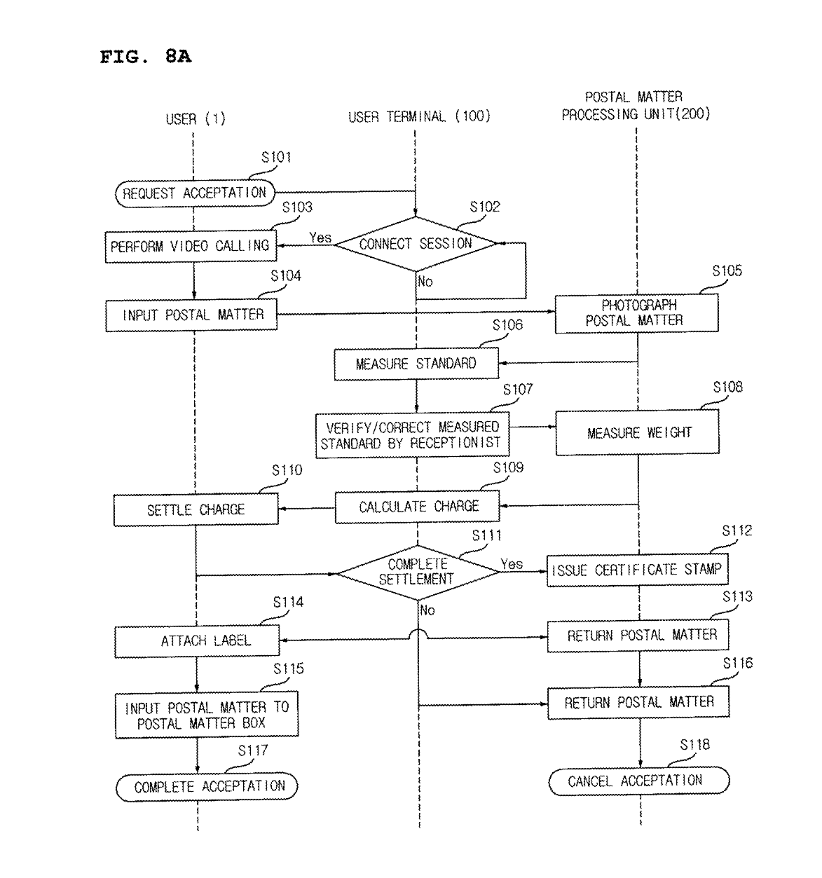

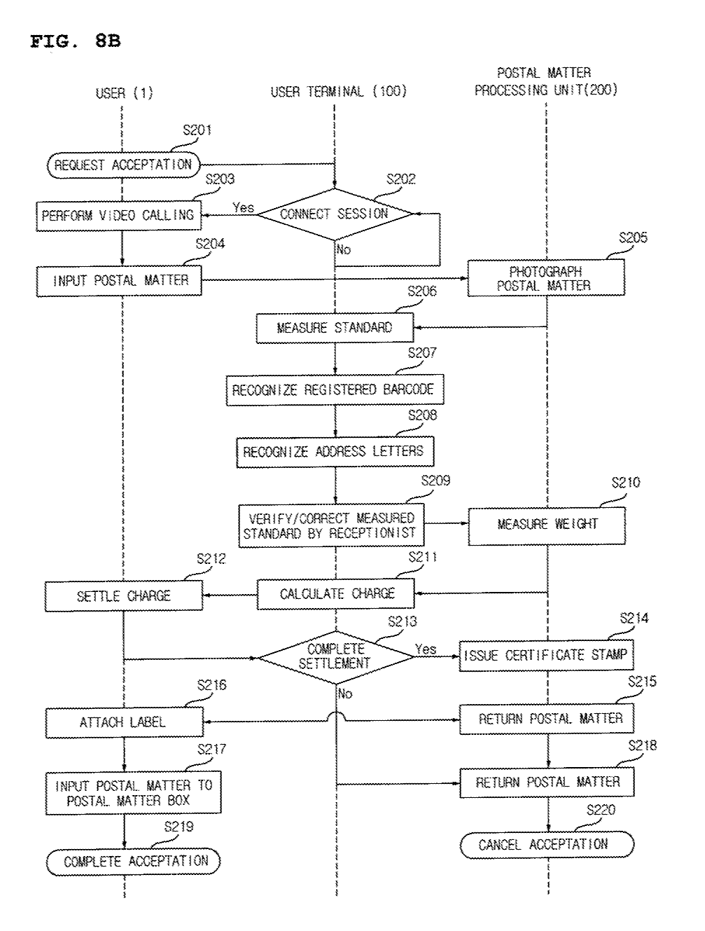

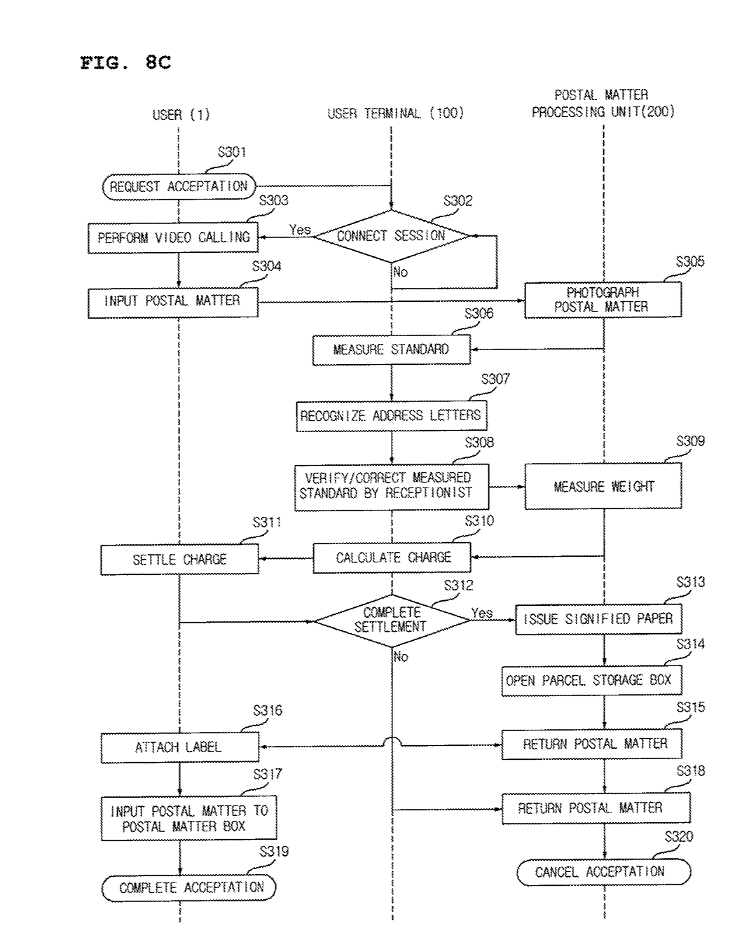

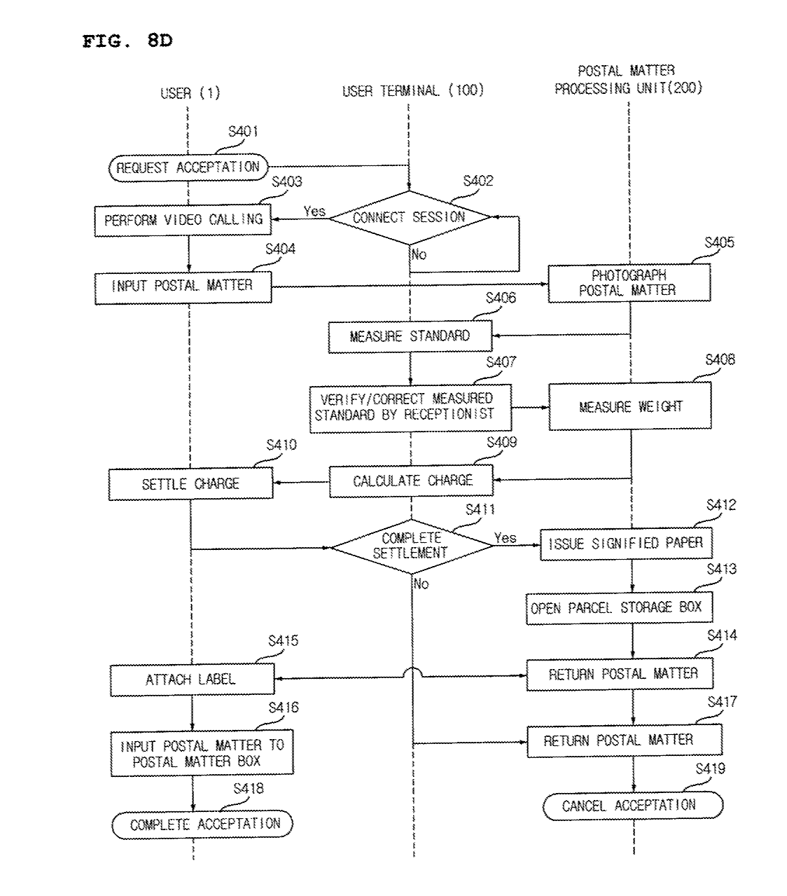

When an accepting method for each acceptation type will be described in more detail with reference to FIGS. 8A, 8B, 8C, and 8D, a general postal accepting process is illustrated in FIG. 8A.

The user requests acceptation (S101), and the user terminal 100 performs session connection of a usable communication session (S102). The user performs video calling through the communication session (S103), and performs an operation for acceptation through the video calling.

When the postal matter is input (S104), the postal matter is photographed by the image information acquiring unit 220 of the postal matter processing unit 200 (S105), the user terminal 100 measures a standard by using the photographed image information (S106), and the receptionist verifies and corrects the measured standard (S107).

Subsequently, the weight measuring unit 230 of the postal matter processing unit 200 measures a weight (S108), and the user terminal 100 calculates a charge (S109). The user settles the charge (S110), and when the charge is settled (S111), a certificate stamp is issued (S112). When the charge is not settled, the postal matter is returned (S116) and the acceptation is cancelled (S118).

The certificate stamp issued postal matter is returned to the user (S113), and the user attaches a label (S114) and inputs the postal matter to the box (S115), and then finishes the acceptation (S117).

FIG. 8B illustrates a registration accepting process as follows.

The user requests acceptation (S201), and the user terminal 100 performs session connection of a usable communication session (S202). The user performs video calling through the communication session (S203), and performs an operation for acceptation through the video calling.

When the postal matter is input (S204), the postal matter is photographed by the image information acquiring unit 220 of the postal matter processing unit 200 (S205), the user terminal 100 measures a standard by using the photographed image information (S206), recognizes a registered barcode (S207), and recognizes address letters (S208), and then the receptionist verifies and corrects the measured and recognized information (S209).

Subsequently, the weight measuring unit 230 of the postal matter processing unit 200 measures a weight (S210), and the user terminal 100 calculates a charge (S211). The user settles the charge (S212), and when the charge is settled (S213), a certificate stamp is issued (S214). When the charge is not settled, the postal matter is returned (S218), and the acceptation is cancelled (S220). The certificate stamp issued postal matter is returned to the user (S215), and the user attaches a label (S216) and inputs the postal matter to the box (S217), and then finishes the acceptation (S219).

FIG. BC illustrates a parcel accepting process as follows. The user requests acceptation (S301), and the user terminal 100 performs session connection of a usable communication session (S302). The user performs video calling through the communication session (S303), and performs an operation for acceptation through the video calling.

When the postal matter is input (S304), the postal matter is photographed by the image information acquiring unit 220 of the postal matter processing unit 200 (S305), the user terminal 100 measures a standard by using the photographed image information (S306), and recognizes address letters (S307), and then the receptionist verifies and corrects the measured standard and the recognized address letters (S308).

Subsequently, the weight measuring unit 230 of the postal matter processing unit 200 measures a weight (S309), and the user terminal 100 calculates a charge (S310). The user settles the charge (S311), and when the charge is settled (S312), a signified paper is issued (S313), and a usable parcel storage box among the postal matter boxes 270 is opened (S314). When the charge is not settled, the postal matter is returned (S318), and the acceptation is cancelled (S320).

The signified issued postal matter is returned to the user (S315), and the user attaches a label (S316) and inputs the postal matter to the box (opened parcel storage box) (S317), and then finishes the acceptation (S319).

FIG. 3D illustrates an international postal matter accepting process as follows.

The user requests acceptation (S401), and the user terminal 100 performs session connection of a usable communication session (S402). The user performs video calling through the communication session (S403), and performs an operation for acceptation through the video calling.

When the postal matter is input (S404), the postal matter is photographed by the image information acquiring unit 220 of the postal matter processing unit 200 (S405), the user terminal 100 measures a standard by using the photographed image information (S406), and the receptionist verifies and corrects the measured standard (S407).

Subsequently, the weight measuring unit 230 of the postal matter processing unit 200 measures a weight (S408), and the user terminal 100 calculates a charge (S409). The user settles the charge (S410), and when the charge is settled (S411), a signified paper is issued (S412), and a usable parcel storage box among the postal matter boxes 270 is opened (S413). When the charge is not settled, the postal matter is returned (S417), and the acceptation is cancelled (S419).

The signified paper issued postal matter is returned to the user (S414), and the user attaches a label (S415) and inputs the postal matter to the box (opened parcel storage box) (S416), and then finishes the acceptation (S418).

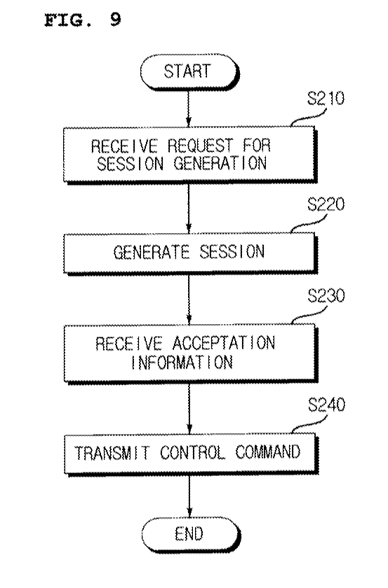

Referring to FIG. 9, a processing method of on-line acceptation of the postal matter according to the exemplary embodiment of the server 20 for on-line accepting a postal matter according to the exemplary embodiment described above/includes a session generation request receiving step (S210), a session generating step (S220), an acceptation information receiving step (S230), and a control command transmitting step (S240).

The session generation request receiving step (S210) receives a request for generation of a communication session for on-line accepting a user's postal matter.

The session generating step (S220) generates the communication session, and the acceptation information receiving step (S230) receives the acceptation information through the generated communication session.

The control command transmitting step (S240) transmits a control command for accepting the postal matter through the generated communication session.

Since detailed contents of the respective steps of the method of on-line accepting the postal matter and the processing method thereof according to the exemplary embodiments described above correspond to respective configurations of the apparatus 10 for on-line accepting a postal matter and the server described above, the detailed description thereof is omitted.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for on-line accepting a postal matter, comprising:
a user terminal configured to transmit acceptation information for accepting a postal matter through a communication session for on-line accepting a user's postal matter or receive a control command for accepting the postal matter; and
a postal matter processing unit configured to extract the acceptation information from the postal matter or perform an operation for accepting the postal matter according to the acceptation control command.

2. The apparatus for on-line accepting a postal matter of claim 1, wherein the user terminal requests generation of the communication session to an server for on-line accepting a postal matter for accepting the postal matter, and the server for on-line accepting a postal matter determines whether a responsive receptionist for accepting the postal matter exists and generates a session with the receptionist.

3. The apparatus for on-line accepting a postal matter of claim 2, wherein the user terminal transmits the acceptation information to the receptionist through the communication session, and receives the control command from the receptionist.

4. The apparatus for on-line accepting a postal matter of claim 1, wherein the user terminal further includes an interface unit which provides a user interface environment which enables the user to input the acceptation information for transmission through the communication session.

5. The apparatus for on-line accepting a post matter of claim 1, wherein the user terminal further includes a charge settlement unit for settling a postal charge of the postal matter.

6. The apparatus for on-line accepting a postal matter of claim 1, wherein the postal matter processing unit further includes an image information acquiring unit for acquiring image information on the postal matter.

7. The apparatus for on-line accepting a postal matter of claim 1, wherein the postal matter processing unit further includes a weight measuring unit for measuring a weight of the postal matter.

8. The apparatus for on-line accepting a postal matter of claim 1, wherein the postal matter processing unit further includes a label issuing unit for issuing a label including information for accepting the postal matter or charge information.

9. The apparatus for on-line accepting a postal matter of claim 1, further comprising:
a postal matter box for storing the accepted postal matter.

10. A server for on-line accepting a postal matter, comprising:
a communication session generating unit configured to receive a request for generation of a communication session for on-line accepting a user's postal matter and generate the session; and
an on-line postal matter accepting unit configured to receive the acceptation information through the communication session or transmit a control command for accepting the postal matter.

11. The server for on-line accepting a postal matter of claim 10, wherein the communication session generating unit includes a session generation request receiving unit configured to receive a request for generation of the communication session from a user terminal; and a session generating unit configured to determine whether a responsive receptionist for accepting the postal matter exists according to the generation request of the communication session and generate a session with the receptionist.

12. The server for on-line accepting a postal matter of claim 11, wherein the receptionist receives the acceptation information through the communication session, and transmits the control command of the receptionist to the user.

13. A method for on-line accepting a postal matter, comprising:
requesting generation of a communication session for on-line accepting a user's postal matter;
transmitting acceptation information for accepting the postal matter through the generated communication session;
receiving a control command for accepting the postal matter through the generated communication session; and
performing an operation for accepting the postal matter according to the acceptation control command.

14. The method for on-line accepting a postal matter of claim 13, wherein in the requesting of the generation of a communication session, generation of the communication session is requested to an server for on-line accepting a postal matter for accepting the postal matter, and the server for on-line accepting a postal matter determines whether a responsive receptionist for accepting the postal matter exists and generates a session with the receptionist.

15. The method for on-line accepting a postal matter of claim 13, wherein in the transmitting of the acceptation information, the acceptation information is transmitted to the receptionist through the communication session, and in the receiving of the control command, the control command is received from the receptionist.

16. A processing method for on-line accepting a postal matter, comprising:
receiving a request for generation of a communication session for on-line accepting a user's postal matter;
generating the communication session;
receiving the acceptation information through the generated communication session; and
transmitting a control command for accepting the postal matter through the generated communication session.

17. The processing method for on-line accepting a postal matter of claim 16, wherein in the generating of the communication session, whether a responsive receptionist for accepting the postal matter exists is determined according to the generation request of the communication session, and a session with the receptionist is generated.

18. The processing method for on-line accepting a postal matter of claim 17, wherein in the transmitting of the control command, the control command of the receptionist is transmitted.
